(19) United States
(12) Patent Application Publication
(10) Pub. No.: US 2015/0370992 A1
(43) Pub. Date: Dec. 24, 2015

(54) SYNTHETIC HEALTHCARE DATA GENERATION

(71) Applicant: HEWLETT-PACKARD DEVELOPMENT COMPANY, L.P., Houston, TX (US)

(72) Inventors: Wen Yao, Palo Alto, CA (US); Sujoy Basu, Sunnyvale, CA (US); Wei-Nchih Lee, Palo Alto, CA (US); Sharad Singhal, Belmont, CA (US)

(21) Appl. No.: 14/762,590

(22) PCT Filed: Jan. 31, 2013
(86) PCT No.: PCT/US2013/024137

§ 371 Date: Jul. 22, 2015

(51) Int. Cl. G06F 19/00; G06F 17/18

(52) U.S. Cl. CPC G06F 19/3437; G06F 17/18

(57) ABSTRACT

Synthetic healthcare data generation can include receiving an indication of a particular quantity of people, receiving an indication of a particular quantity of time periods, assigning a respective set of characteristics to each of the people based on a statistical model, simulating a respective path for each of the people through a set of clinical practice guidelines over the specified time periods, wherein each path is determined based on the respective set of characteristics, determining a probability associated with a progression of a medical condition for each of the people at the end of each time period, and generating a synthetic data set for each of the people based on the simulated paths and the determined probabilities.

### BACKGROUND

Healthcare data (e.g., clinical datasets) can be used for various purposes such as, for example, modeling and/or predicting disease progression and/or improving operational efficiency in medical facilities. Such data can be used outside the medical domain for purposes such as performance testing, usability testing, and/or education, for instance.

Actual clinical data, however, may not be readily available due to privacy laws (e.g., the Health insurance Portability and Accountability Act (HIPAA)), for instance. Efforts associated with de-identifying actual clinical data so that it can be used for such purposes may be costly.

### BRIEF DESCRIPTION OF THE DRAWINGS

FIG. 1 illustrates an example of a flow chart associated with synthetic healthcare data generation according to the present disclosure.

FIG. 2 illustrates an example of a process model including a set of clinical practice guidelines associated with type 2 diabetes according to the present disclosure.

FIG. 3 illustrates an example of a Markov model for generating synthetic healthcare data according to the present disclosure.

FIG. 4 illustrates an example of a method for generating synthetic healthcare data according to the present disclosure.

FIG. 5 illustrates a block diagram of an example of a system for generating synthetic healthcare data according to the present disclosure.

### DETAILED DESCRIPTION

Examples of the present disclosure can generate (e.g., create and/or modify) synthetic healthcare data. Synthetic healthcare data can include one or more clinical datasets, synthetic individual medical health records, and/or other synthetic (e.g., simulated) healthcare data capable of being populated into an Electronic Health Records (ERR) database as synthetic EHR data (sometimes generally referred to herein as ERR data).

Synthetic healthcare data can be generated in an effort to mimic actual healthcare data. The usefulness of such synthetic data in scenarios such as performance testing, usability testing, and/or education, for instance, may depend on how accurately the synthetic data represents a patient population.

EHR data can be used to improve overall health care delivery through usability testing, performance testing, and/or educational purposes, for instance, among others. EHR data generated by examples discussed herein can include clinical activities, attending providers, and/or resulting medical data, including timestamps associated with each, for instance. ERR data generated by examples discussed herein can document a disease as it progresses over a span of multiple years. EHR data generated by examples discussed herein can include administrative and/or medical data following distributions of parameters and/or attributes attached to clinical activities along with timestamps associated with such activities. Accordingly, examples discussed herein can be used by practitioners and/or researchers in generating ERR data for various purposes when privacy is a concern (e.g., access to actual healthcare data is limited).

While prior solutions to ERR data generation may lack robustness, intricacies, and/or complexities inherent in real world healthcare datasets, examples discussed herein can generate realistic EHR data through the use of various models. For example, ERR data can be generated based initially on the distributions of parameters in the patient population using a statistical model. EHR data generated by examples of the present disclosure can simulate (e.g., generate and/or track simulated) pathways of the patient population through clinical practice guidelines and capture logical and/or temporal relationships between clinical activities, providers, and resulting data using a process model. In addition, EHR data generated by examples of the present disclosure can capture disease progression spanning multiple years using a Markov model.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

As used herein, “a” or “a number of” something can refer to one or more such things. For example, “a number of articles” can refer to one or more articles.

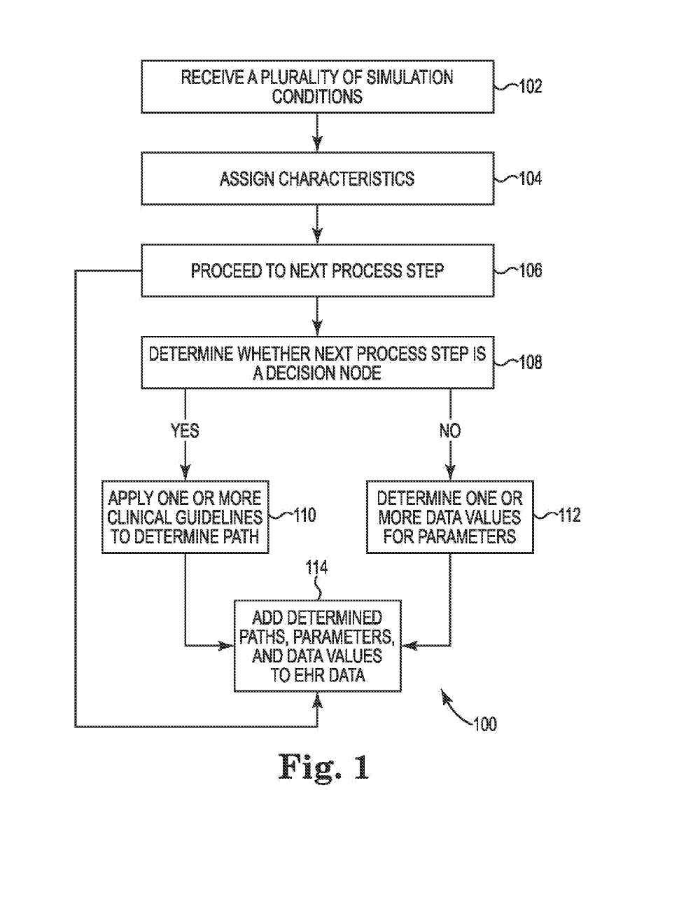

FIG. 1 illustrates an example flow chart 100 associated with synthetic healthcare data generation according to the present disclosure. Various blocks (e.g., steps) of flow chart 100 can be performed by the execution of instructions by processing resources (discussed below), for instance.

At block 102, flow chart 100 can include receiving a plurality of simulation conditions. Simulation conditions can be received from one or more user inputs (e.g., user-specified). Simulation conditions can be received from and/or generated randomly. Simulation conditions can include an indication of a particular number of people (e.g., simulated people and/or simulated patients) for which to generate EHR data. Such people can share a particular medical condition such as diabetes and/or hypertension, for instance, though examples of the present disclosure do not limit medical condition(s) to a particular type. For purposes of illustration, various examples are discussed herein using the particular condition of type 2 diabetes, though such examples are not to be taken in a limiting sense.

Numbers of people indicated are not limited by examples of the present disclosure, though it is noted that a larger number of people (e.g., 100,000) may be more likely to yield simulated EHR data resembling actual EHR data than would a smaller number of people (e.g., 1,000). Simulation conditions can include an indication of a particular number of time periods to run the simulation. A duration of a time period (e.g., one year, one month, two years, etc.) can be determined by a user and/or automatically (e.g., by a computing device and/or random number generator), for instance.

At block 104, flow chart 100 can include assigning a respective set of characteristics (e.g., attributes) to each of the people (e.g., the number of people specified at block 102) based on a statistical model. Assigning characteristics to people can allow the generation of a simulated population of people having diabetes, for instance, with distributions of characteristics similar to an actual population (e.g., a desired population to be simulated). A simulated population can be generated to represent various populations (e.g., a national population, a state population, an ethnic population, etc.). Characteristics can include probabilities of various population parameters. For example, varying probabilities of blood pressure measurements, body temperature measurements, age, gender, race, symptoms, fasting glucose, medication usage, comorbidity, etc. can be assigned to people of the population.

Various examples can use statistical models to generate the population and/or assign characteristics to each person such that the simulated population as a whole can be representative of the actual population. For example, demographic data such as gender, age, ethnicity, race, and/or weight, for instance, among various other data, can be used to assign characteristics to people. A user can specify data, characteristics, and/or a desired distribution. For example, a user may specify that the population is to include men and not women.

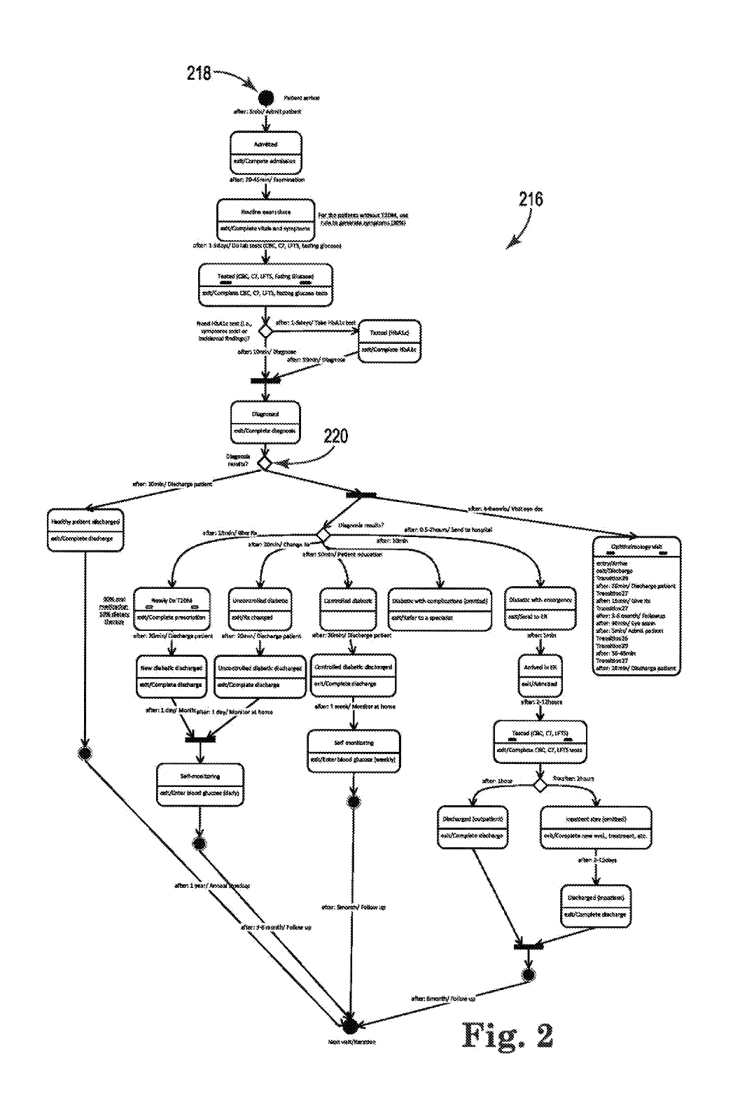

At block 106, flow chart 100 can include each person of the population proceeding to a next process step in a set of clinical practice guidelines. A set of clinical practice guidelines associated with type 2 diabetes is illustrated as process model 216 in FIG. 2 and is referred to as an example herein. Process model 216 (e.g., the set of clinical practice guidelines) can include one or more sets (e.g., portions of sets) of clinical practice guidelines. A set of clinical practice guidelines can include a plurality of clinical guidelines (discussed below).

Process steps are illustrated in FIG. 2 as boxes and/or diamonds. A “next” process step, as used herein, can refer to a first process step (illustrated in FIG. 2 as first process step 218) in instances where no other steps of process model 216 have been reached. In other instances, a next process step can refer to an immediately subsequent step with respect to a current step (e.g., a step that has been reached). An immediately subsequent step can depend, for example, on whether a current step is a decision node and/or the application of one or more clinical guidelines thereat (discussed further below).

At block 108, flow chart 100 can include determining whether the next process step is a decision node. A decision node can be a step in process model 216 having a plurality of next steps and/or paths extending therefrom (e.g., possible and/or potential next steps). A particular (e.g., recommended and/or correct with respect to medical procedure) next step from a decision node can be determined based on the application of one or more clinical guidelines. Decision nodes are illustrated in FIG. 2 as diamonds (e.g., step 220). For example, step 220 branches into a plurality of next steps depending on a diagnosis of diabetes and/or a severity thereof.

If the next step is a decision node, flow chart 100, at block 110 can include determining a path from the next step based on the application of one or more clinical guidelines (e.g., “best practices”). Clinical guidelines can be one or more evidence-based, standardized, established, common, and/or known clinical practices typically used by a medical practitioner (e.g., doctor and/or nurse) based on information regarding a particular stage of a medical condition, prognosis, and/or diagnosis. To apply clinical guidelines, a practitioner can use statistical models such as those previously discussed (e.g., demographic information), diagnoses, patient history, data generated at previous steps, etc.

For example, if a patient is determined to be a controlled diabetic, one or more clinical guidelines may indicate that the patient can be discharged. If, however, a patient is discovered through testing to be a diabetic with complications (e.g., glaucoma), one or more clinical guidelines may indicate that the patient should be referred to a specialist (e.g., an ophthalmologist). Examples of the present disclosure can apply such clinical guidelines to a simulated person as they progress through process model 216 to determine subsequent path(s) through process model 216 based on the characteristics assigned to the person.

If the next step is a clinical activity and not a decision node, flow chart 100, at block 112, can include determining (e.g., generating) one or more data values associated with one or more parameters of the clinical activity based on the respective set of characteristics previously assigned at block 104. Clinical activities can be tests, diagnoses, conversations, etc. tending to lead to the generation of EHR data. For example, a clinical activity can be a medical practitioner diagnosing various symptoms. Parameters of a clinical activity can include information capable of being determined during, and/or otherwise associated with, a clinical activity. Data values associated with the parameters can be values determined for the parameters.

For example, if a clinical activity includes testing to determine a patient's level of glycosylated hemoglobin (HbA1c), the level of HbA1c can be the parameter, and the particular value for the level of HbA1c can be the data value (e.g., 40 mmol/mol). Data values can include times and/or durations. Data values can be determined based on the respective set of characteristics previously assigned at block 104. For example, a person that was assigned an increased probability of a high HbA1c level may be more likely to be found with a higher level of HbA1c during a clinical activity than another person assigned a decreased probability of a high HbA1c level.

At block 114, flow chart 100 includes adding the paths determined from the decision nodes, the parameters of the clinical activities, and the data values associated with the parameters of the clinical activities for each patient to EHR data associated with that person (e.g., the person's medical records). Such added information can include timestamps associating the data with particular times, days, months, years, etc. The addition of such information can represent a simulation of a respective path for each of the people through the set of clinical practice guidelines. The EHR data can thus resemble actual data that would be documented during an actual patient visit and/or multiple patient visits to one or more medical practitioners over a period of time.

Subsequent to block 114, flow chart 100 can include a return to block 106 where the simulated person can advance to a next step in the process model 216 and steps 108, 110, 112, and/or 114 can be repeated. Such repetition can continue, for instance, until the specified number of time periods has elapsed. Such repetition can continue, for instance, until all people of the generated population have proceeded through process model 216.

FIG. 2 illustrates a process model 216 including a set of clinical practice guidelines associated with type 2 diabetes according to the present disclosure. Process model 216 can be a mapping of possible paths taken by a person associated with a diagnosis and/or treatment of type 2 diabetes. As shown in FIG. 2, process model 216 can begin at first process step 218 when a person (e.g., patient) arrives (e.g., arrives at a location associated with a medical practitioner). Process model 216 can include a single medical practitioner (e.g., doctor) and/or medical′provider (e.g., general health clinic). Process model 216 can include a plurality of practitioners and/or providers.

As previously discussed, process model 216 can include decision nodes (e.g., step 220). Decision nodes are illustrated in FIG. 2 as diamonds. A decision node can be a step in process model 216 with a plurality of next steps (e.g., potential next steps), where a particular (e.g., recommended and/or correct with respect to medical procedure) next step can be determined based on the application of one or more clinical guidelines.

As previously discussed, process model 216 can include clinical activities. Clinical activities can be tests, diagnoses, conversations, etc. tending to lead to the recording and/or generation of EHR data. For example, a clinical activity can be a medical practitioner performing a test for diagnosing type 2 diabetes on a patient.

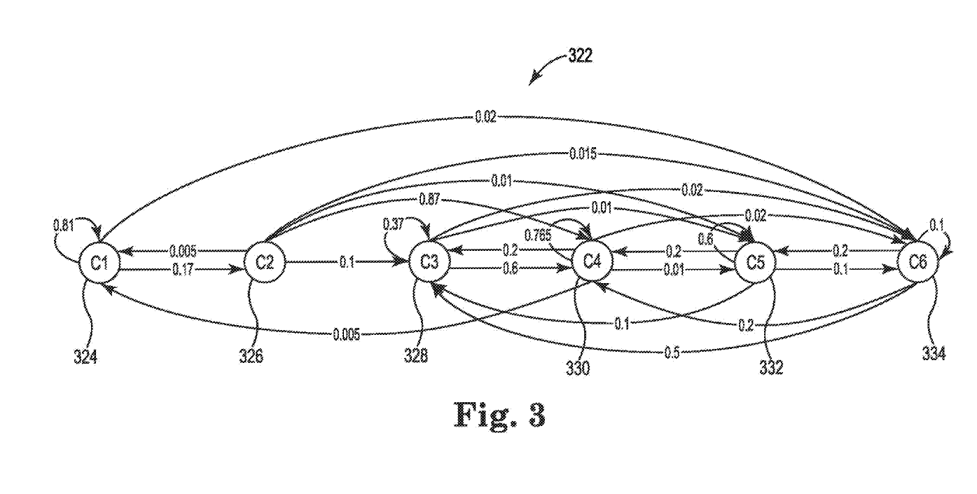

FIG. 3 illustrates an example Markov model 322 for generating synthetic healthcare data according to the present disclosure. Markov model 322 can be used to monitor a medical condition (e.g., type 2 diabetes) as it progresses over the course of multiple time periods, for instance. As shown in Markov model 322, type 2 diabetes can be considered to include six states. Markov model 322 includes a healthy state 324 (C1), a newly diagnosed diabetic state 326 (C2), an uncontrolled diabetic state 328 (C3), a controlled diabetic state 330 (C4), a diabetic with complications state 332 (C5), and a diabetic with emergency state 334 (C6). The six states illustrated in Markov model 322 are sometimes generally referred to herein as states 324-334. While Markov model 322 illustrates a Markov model associated with type 2 diabetes, the present disclosure is not limited to a particular model and/or medical condition, as previously discussed.

As illustrated by arrows between the states 324-334, a person and/or people of the population in a particular state can transition to another state and/or remain in the particular state. Probabilities of transitioning from a state to various others of states 324-332 are illustrated in FIG. 3 as values between 0 and 1. Such probabilities are additionally illustrated as a transition matrix in Table 1. It is noted that portions of Table 1 including an “X” indicate that no probability is recognized for such a transition (e.g., there may be insufficient likelihood of transitioning from an uncontrolled diabetic to a newly diagnosed diabetic such that it would be assigned a probability).

TABLE 1

probability

| State | C1 | C2 | C3 | C4 | C5 | C6 |
|---|---|---|---|---|---|---|
| C1 | 0.81 | 0.17 | X | X | X | 0.02 |
| C2 | 0.005 | X | 0.1 | 0.87 | 0.01 | 0.015 |
| C3 | X | X | 0.37 | 0.6 | 0.01 | 0.02 |
| C4 | 0.05 | X | 0.2 | 0.765 | 0.2 | 0.02 |
| C5 | X | X | 0.1 | 0.2 | 0.6 | 0.1 |
| C6 | X | X | 0.5 | 0.2 | 0.2 | 0.1 |

Examples of the present disclosure can use Markov model 322 to simulate a progression of a medical condition over time. Various examples can generate synthetic healthcare data that captures longitudinal intricacies of medical conditions (e.g., longitudinal dataset(s)). That is, various examples can generate synthetic healthcare data that captures intricacies of medical conditions spanning multiple time periods. For example, at the end of each time period (discussed above in connection with FIG. 1), a probability associated with a progression (e.g., a transition from one state to another state) of a medical condition can be determined for each person of the population.

For example, at the end of a first time period (e.g., year one), a respective state (e.g., state 326) of the medical condition for each person (e.g., a percentage of the population) can be determined. Such a determination can be made based on knowledge regarding the population (e.g., using population statistics), for instance. At the end of a second time period (e.g., year two), a respective probability associated with a transition from the state of the medical condition at the end of the first time period to another state (e.g., state 328) of the medical condition at the end of a consecutive time period subsequent to the first time period can be determined. In Markov model 322, and with reference to Table 1, such a probability can be determined to be 0.1, for instance. The determined probabilities can be added to EHR data associated each of the people in the population and/or to the population as a whole. A similar process can occur for each time period until the simulation is stopped, and/or the specified number of time periods has elapsed.

Various examples can include determining a plurality of probabilities, each associated with a different progression of the medical condition. For example, if a person is in a first state at the end of a first time period (e.g., state 328 (C3), FIG. 3 and Table 1 indicate that the person can transition from the first state in a plurality of ways by the end of the second time period. A probability of the person remaining at the first state can be 0.37. A probability of the person transitioning to a second state (state 330 (C4)) can be 0.6. A probability of the person transitioning to a third state (state 332 (C5)) can be 0.01. A probability of the person transitioning to a fourth state (state 334 (C6)) can be 0.02. Thus, examples can include the determination of a plurality of probabilities. The determined probabilities can be added to EHR data associated each of the people in the population and/or to the population as a whole.

As previously discussed, a probability associated with a progression of the medical condition can be determined for each person of the population at the end of each time period. The probability can be used to determine a path taken by the person for a next time period, for instance. Accordingly, a path for each person through process model 216 (previously discussed) can differ from time period to time period and can show the progression of the medical condition throughout the population over the number of time periods.

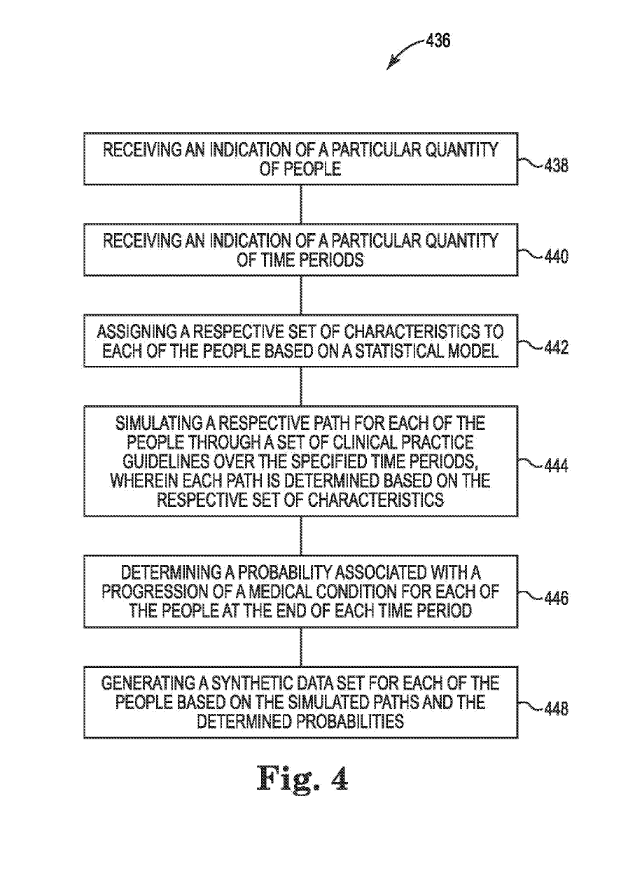

FIG. 4 illustrates an example of a method 436 for generating synthetic healthcare data according to the present disclosure. Method 436 can be performed by utilizing software, hardware, firmware, and/or logic, for instance.

At block 438, method 436 includes receiving an indication of a particular quantity of people. An indication of a quantity of people can be made by one or more users, for instance.

At block 440, method 436 includes receiving an indication of a particular quantity of time periods. An indication of as quantity of time periods can be made by one or more users, for instance.

At block 442, method 436 includes assigning a respective set of characteristics to each of the people based on a statistical model. Characteristics can be assigned according to one or more population distributions. Assigning the respective set of characteristics can include assigning a probability associated with a population parameter to each of the people (e.g., in manner analogous to that previously discussed), for instance.

At block 444, method 436 includes simulating (e.g., generating and/or tracking) a respective path for each of the people through a set of clinical practice guidelines over the specified time periods, wherein each path is determined based on the respective set of characteristics. Each path can be determined based on a plurality of applications of a plurality of clinical guidelines (e.g., in a manner analogous to that previously discussed), for instance. The clinical guidelines can include a plurality of medical providers and/or practitioners. The clinical guidelines can be based on the respective set of characteristics. For example, certain tests may be performed only on particular segments and/or portions of the population (e.g., women) and omitted on others (e.g., men). The characteristics can change (e.g., over one or more time periods). For example, age, body temperature, etc. can change between time periods. Thus, the characteristics assigned to a particular person can, for instance, dictate what clinical guidelines are applied. Further, the data generated throughout the set of clinical practice guidelines can dictate what clinical guidelines are applied, for instance.

At block 446, method 436 includes determining a probability associated with a progression of a medical condition for each of the people at the end of each time period.

At block 448, method 436 includes generating a synthetic data set for each of the people based on the simulated paths and the determined probabilities. The synthetic data set can be an electronic health record, for instance.

Method 436 can include comparing the generated data set with various assumptions and/or expectations regarding distribution(s) (e.g., distributions of parameters) in the population. Such a comparison can allow validation and/or conformance checking, for instance, to ensure the generated data is sufficiently representative of an actual population and/or an expected result. Comparing can include determining whether the comparison exceeds a particular threshold (e.g., whether the generated data set and the distributions are sufficiently related, matching, and/or equivalent).

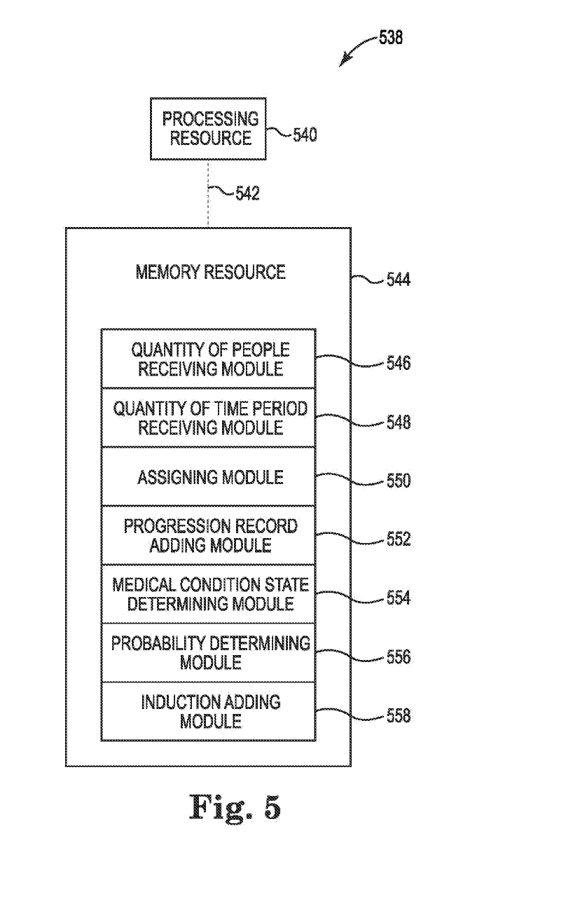

FIG. 5 illustrates a block diagram of an example of a system 538 according to the present disclosure. The system 538 can utilize software, hardware, firmware, and/or logic to perform a number of functions.

The system 538 can be any combination of hardware and program instructions configured to share information. The hardware, for example can include a processing resource 540 and/or a memory resource 544 (e.g., computer-readable medium (CRM), machine readable medium (MRM), database, etc.) A processing resource 540, as used herein, can include any number of processors capable of executing instructions stored by a memory resource 544. Processing resource 540 may be integrated in a single device or distributed across multiple devices. The program instructions (e.g., computer-readable instructions (CRI)) can include instructions stored on the memory resource 544 and executable by the processing resource 540 to implement a desired function (e.g., generating synthetic healthcare data).

The memory resource 544 can be in communication with a processing resource 540. A memory resource 544, as used herein, can include any number of memory components capable of storing instructions that can be executed by processing resource 540. Such memory resource 544 can be a non-transitory CRM. Memory resource 544 may be integrated in a single device or distributed across multiple devices. Further, memory resource 544 may be fully or partially integrated in the same device as processing resource 540 or it may be separate but accessible to that device and processing resource 540. Thus, it is noted that the system 538 may be implemented on a user and/or a participant device, on a server device and/or a collection of server devices, and/or on a combination of the user device and the server device and/or devices.

The processing resource 540 can be in communication with a memory resource 544 storing a set of CRI executable by the processing resource 540, as described herein. The CRI can also be stored in remote memory managed by a server and represent an installation package that can be downloaded, installed, and executed. The system 538 can include memory resource 544, and the processing resource 540 can be coupled to the memory resource 544.

Processing resource 540 can execute CRI that can be stored on an internal or external memory resource 544. The processing resource 540 can execute CRI to perform various functions, including the functions described with respect to FIGS. 1, 2, 3, and 4. For example, the processing resource 540 can execute CRI to assign a respective set of characteristics to each of the people based on a statistical model.

A number of modules 546, 548, 550, 552, 554, 556, 558 can include CRI that when executed by the processing resource 540 can perform a number of functions. The number of modules 546, 548, 550, 552, 554, 556, 558 can be sub-modules of other modules. The number of modules 546, 548, 550, 552, 554, 556, 558 can comprise individual modules at separate and distinct locations (e.g., CRM, etc.).

A quantity of people receiving module 546 can include CRI that when executed by the processing resource 540 can receive an indication of a particular quantity of people sharing a particular medical condition. As described herein the quantity of people receiving module 540 can receive an indication of a particular quantity of people made by a user, for instance.

A quantity of time period receiving module 548 can include CRI that when executed by the processing resource 540 can receive an indication of a particular quantity of time periods. As described herein the quantity of time period receiving module 548 can receive an indication of a particular quantity of time periods made by a user, for instance.

An assigning module 550 can include CRI that when executed by the processing resources 540 can assign a respective set of characteristics to each of the people based on a statistical model. The assigning module 550 can assign characteristics to people allowing the generation of a simulated population of people having a particular medical condition, for instance, with distributions of characteristics similar to an actual population (e.g., a desired population to be simulated).

The progression record adding module 552 can include CRI that when executed by the processing resource 540 can add, to a respective simulated health record associated with each person, a respective record of a progression of each simulated person through a set of clinical practice guidelines.

A medical condition state determining module 554 can include CRI that when executed by the processing resource 540 can determine a respective state of the medical condition for each person at the end of a first time period.

A probability determining module 556 can include CRI that when executed by the processing resource 540 can determine a respective probability associated with a transition from the state of the medical condition at the end of the first time period to another state of the medical condition at the end of a consecutive time period subsequent to the first time period. The probability determining module 556 can determine another probability associated with no transition from the state of the medical condition at the end of the first time period to the other state of the medical condition at the end of the consecutive time period, for instance. The probability determining module 556 can determine a respective probability associated with each of a plurality of transitions from the state of the medical condition at the end of the first period to a respective plurality of other states of the medical condition at the end of the consecutive time period, for instance.

An indication adding module 558 can include CRI that when executed by the processing resource 540 can add an indication of the respective state of the medical condition and an indication of the respective probability to each simulated health record. The indication adding module 558 can add an indication of the other probability (e.g., the probability associated with no transition from the state of the medical condition at the end of the first time period to the other state of the medical condition at the end of the consecutive time period) to each simulated health record. The indication adding module 558 can add an indication of the respective probabilities associated with each of the plurality of transition to each respective simulated health-record.

A memory resource 544, as used herein, can include volatile and/or non-volatile memory. Volatile memory can include memory that depends upon power to store information, such as various types of dynamic random access memory (DRAM), among others. Non-volatile memory can include memory that does not depend upon power to store information.

The memory resource 544 can be integral, or communicatively coupled, to a computing device, in a wired and/or a wireless manner. For example, the memory resource 544 can be an internal memory, a portable memory, a portable disk, or a memory associated with another computing resource (e.g., enabling CRIs to be transferred and/or executed across a network such as the Internet).

The memory resource 544 can be in communication with the processing resource 540 via a communication link (e.g., path) 542. The communication link 542 can be local or remote to a machine (e.g., a computing device) associated with the processing resource 540. Examples of a local communication link 542 can include an electronic bus internal to a machine (e.g., a computing device) where the memory resource 542 is one of volatile, non-volatile, fixed, and/or removable storage medium in communication with the processing resource 540 via the electronic bus.

The communication link 542 can be such that the memory resource 544 is remote from the processing resource (e.g., 540), such as in a network connection between the memory resource 544 and the processing resource (e.g., 540). That is, the communication link 542 can be a network connection. Examples of such a network connection can include a local area network (LAN), wide area network (WAN), personal area network (PAN), and the Internet, among others. In such examples, the memory resource 544 can be associated with a first computing device and the processing resource 540 can be associated with a second computing device (e.g., a Java® server). For example, a processing resource 540 can be in communication with a memory resource 544, wherein the memory resource 544 includes a set of instructions and wherein the processing resource 540 is designed to carry out the set of instructions.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method, comprising:
receiving an indication of a particular quantity of people;
receiving an indication of a particular quantity of time periods;
assigning a respective set of characteristics to each of the people based on a statistical model;
simulating a respective path for each of the people through a set of clinical practice guidelines over the specified time periods, wherein each path is determined based on the respective set of characteristics;
determining a probability associated with a progression of a medical condition for each of the people at the end of each time period; and
generating a synthetic data set for each of the people based on the simulated paths and the determined probabilities.

2. The method of claim 1, wherein the synthetic data set is a synthetic electronic health record.

3. The method of claim 1, wherein assigning the respective set of characteristics to each of the people includes assigning a probability associated with a population parameter to each of the people.

4. The method of claim 1, wherein each path is determined based on a plurality of applications of a plurality of clinical guidelines.

5. The method of claim 4, wherein at least one of the plurality of clinical guidelines is based on the respective set of characteristics.

6. The method of claim 5, wherein the respective path through the set of clinical guidelines includes a plurality of medical providers.

7. The method of claim 1, wherein the method includes determining whether a comparison between the generated data set and a plurality of distributions of the statistical model exceeds a particular threshold.

8. A non-transitory computer-readable medium storing instructions executable by a processor to cause a computer to:
generate a simulated population of people sharing a particular medical condition, wherein each simulated person of the population is assigned a respective set of characteristics based on a statistical model; and
document a respective progression of each simulated person through a set of clinical practice guidelines, wherein the set of clinical practice guidelines includes:
a plurality of decision nodes, wherein a particular path from each decision node is determined using a clinical guideline; and
a plurality of clinical activities, wherein a plurality of data values associated with a plurality of parameters of the clinical activities are determined based on the respective set of characteristics.

9. The medium of claim 8, wherein at least one of the plurality of decision nodes includes at least two paths extending therefrom.

10. The medium of claim 8, wherein the instructions are executable by the processor to cause the computer to determine:
a respective time associated with each of the plurality of clinical activities; and
a respective duration associated with each of the plurality of clinical activities.

11. The medium of claim 8, wherein the instructions are executable by the processor to cause the computer to determine a respective time associated with each determination of each data value of the plurality of data values.

12. The medium of claim 8, wherein the instructions are executable by the processor to cause the computer to generate a dataset representing the respective progression over a particular period of time, wherein the data set includes:
the plurality of determined data values;
a respective time associated with each of the plurality of clinical activities; and
a respective time associated with each determination of each data value of the plurality of data values.

13. A system, comprising a processing resource in communication with a non-transitory computer readable medium, wherein the non-transitory computer readable medium includes a set of instructions and wherein the processing resource is designed to carry out the set of instructions to:
receive an indication of a particular quantity of people sharing a particular medical condition;
receive an indication of a particular quantity of time periods;
assign a respective set of characteristics to each of the people based on a statistical model;
add, to a respective simulated health record associated with each person, a respective record of a progression of each simulated person through a set of clinical practice guidelines;
determine a respective state of the medical condition for each person at the end of a first time period;
determine a respective probability associated with a transition from the state of the medical condition at the end of the first time period to another state of the medical condition at the end of a consecutive time period subsequent to the first time period; and
add en indication of the respective state of the medical condition and an indication of the respective probability to each simulated health record.

14. The system of claim 13, wherein the processing resources designed to carry out the set of instructions to:
determine another probability associated with no transition from the state of the medical condition at the end of the first time period to the other state of the medical condition at the end of the consecutive time period; and
add an indication of the other probability to each simulated health record.

15. The system of claim 13, wherein the processing resource is designed to carry out the set of instructions to:
determine a respective probability associated with each of a plurality of transitions from the state of the medical condition at the end of the first period to a respective plurality of other states of the medical condition at the end of the consecutive time period; and
add an indication of the respective probabilities associated with each of the plurality of transition to each respective simulated health record.
